(19) United States
(12) Patent Application Publication
(10) Pub. No.: US 2026/0301424 A1
(43) Pub. Date: Oct. 1, 2026

(54) MODEL LEARNING DEVICE, MODEL LEARNING METHOD, AND STORAGE MEDIUM

(71) Applicant: HONDA MOTOR CO., LTD., Tokyo (JP)

(72) Inventor: Naoki Mori, Tokyo (JP)

(21) Appl. No.: 19/542,693

(22) Filed: Feb. 18, 2026

(30) Foreign Application Priority Data
Mar. 28, 2025 (JP) 2025-056504

(51) Int. Cl. G06V 20/58; G06T 7/73

(52) U.S. Cl. CPC G06V 20/58; G06T 7/73; G06T 2207/20081; G06V 2201/07

(57) ABSTRACT

A model learning device: acquires position information of detection points detected from objects in the vicinity of the mobile body from an external sensor mounted in the mobile body with the camera and at least a part of a detection range overlapping each other; and acquires position information of pixels by associating the pixels of the image and the detection points with each other on the basis of the image and results of acquisition of the position information, and the processor acquires position information of target pixels for which no corresponding detection point is present among the pixels on the basis of results of acquisition of the position information.

### CROSS-REFERENCE TO RELATED APPLICATION

This application is based upon and claims the benefit of priority from Japanese Patent Application No. 2025-056504, filed Mar. 28, 2025, the entire contents of which is incorporated herein by reference.

### BACKGROUND

### Field of the Invention

The present invention relates to a model learning device, a model learning method, and a storage medium.

### Description of Related Art

Conventional techniques for associating camera images acquired by a camera with information acquired from external sensors other than the camera are known. For example, International Publication No. WO 2024/228330 discloses a technique in which a corresponding point that corresponds to an observation point detected using measurement light by a three-dimensional sensor is detected in a camera image acquired by a camera, and parameters indicating a positional relation between the three-dimensional sensor and the camera are corrected on the basis of the position of the observation point in a predetermined three-dimensional coordinate system and the position of the corresponding point in a two-dimensional coordinate system of the camera image.

However, the conventional technique described above is for the purpose of calibration of a LiDAR and a camera and thus is limited to detection of corresponding points of a camera image that correspond to observation points of a LiDAR. In other words, in the conventional technique, there was no motivation to derive position information for pixels in a camera image for which no corresponding LiDAR detection point exists.

### SUMMARY

The present invention is in consideration such situations, and one object thereof is to provide a model learning device, a control method, and a storage medium capable of improving collection efficiency of learning data for model learning by enhancing association between information of a camera image and information of an external sensor other than a camera.

A model learning device, a model learning method, and a storage medium according to the present invention employ the following configurations.

(1): According to one aspect of the present invention, there is provided a model learning device including: a storage medium storing computer-readable instructions; and a processor connected to the storage medium, the processor executing the computer-readable instructions to: acquire an image of the vicinity of a mobile body from a camera mounted in the mobile body; acquire position information of detection points detected from objects in the vicinity of the mobile body from an external sensor mounted in the mobile body with the camera and at least a part of a detection range overlapping each other; and acquire position information of pixels by associating the pixels of the image and the detection points with each other on the basis of the image and results of acquisition of the position information, in which the processor acquires position information of target pixels for which no corresponding detection point is present among the pixels on the basis of the results of acquisition of the position information.

(2): In the aspect (1) described above, the processor generates a learned model on the basis of the results of acquisition of the position information, the processor generates the learned model by causing a machine learning model to perform learning using a plurality of acquired images as input images, and all the plurality of input images include pixels imaging a predetermined location to be common within an angle of view.

(3): In the aspect (2) described above, the machine learning model has feature quantities of pixels of an image and/or pixels of which feature quantities are a predetermined value or more as outputs.

(4): In the aspect (1) described above, the processor acquires the position information of the target pixels from relative positions between the target pixels in the image and a plurality of associated pixels and position information of the detection points corresponding to the plurality of associated pixels on the basis of the plurality of associated pixels for which the corresponding detection points are present among the pixels of the image.

(5): In the aspect (4) described above, a plurality of detection points corresponding to the plurality of associated pixels have differences in reflection intensity and/or distances that are a predetermined value or less.

(6): According to another aspect of the present invention, there is provided a model learning method using a computer, the model learning method including: acquiring an image of the vicinity of a mobile body from a camera mounted in the mobile body; acquiring position information of detection points detected from objects in the vicinity of the mobile body from an external sensor mounted in the mobile body with the camera and at least a part of a detection range overlapping each other; acquiring position information of pixels by associating the pixels of the image and the detection points with each other on the basis of the image and results of acquisition of the position information of the detection points; and acquiring position information of target pixels for which no corresponding detection point is present among the pixels on the basis of results of acquisition of the position information of the detection points.

(7): According to another aspect of the present invention, there is provided a computer-readable non-transitory storage medium storing a program causing a computer to: acquire an image of the vicinity of a mobile body from a camera mounted in the mobile body; acquire position information of detection points detected from objects in the vicinity of the mobile body from an external sensor mounted in the mobile body with the camera and at least a part of a detection range overlapping each other; acquire position information of pixels by associating the pixels of the image and the detection points with each other on the basis of the image and results of acquisition of the position information of the detection points; and acquire position information of target pixels for which no corresponding detection point is present among the pixels on the basis of results of acquisition of the position information of the detection points.

According to Aspects (1) to (7), by enhancing the association with information of an external sensor other than a camera, the number of pixels of which position information is acquired can be increased, and the amount of learning data can be increased. Furthermore, the efficiency of collection of learning data can be improved. According to Aspects (2) and (3), a learned model can be appropriately generated.

According to Aspect (4), position information of each pixel of an image can be acquired, and thus the number of processes for acquiring learning data can be decreased.

According to Aspect (5), the accuracy of position calculation for pixels of an image having no corresponding detection point can be improved.

### BRIEF DESCRIPTION OF THE DRAWINGS

FIG. 1 is a configuration diagram of a model learning system including a model learning device according to an embodiment.

FIGS. 2A and 2B are diagrams illustrating examples of an image acquired by a camera image acquiring unit.

FIG. 3 is a diagram illustrating an example of position information acquired by an external sensor information acquiring unit.

FIG. 4 is a diagram illustrating a method of acquiring position information of a target pixel using a learning data acquiring unit.

FIG. 5 is a flowchart illustrating an example of the flow in which the learning data acquiring unit acquires learning data.

FIG. 6 is a diagram illustrating an example of the configuration of a machine learning model.

FIG. 7 is a flowchart illustrating an example of the flow of model learning performed by a model learning device.

FIG. 8 is a flowchart illustrating an example of the flow of self-position estimation performed by a subject vehicle M in which a learned model is mounted.

### DESCRIPTION OF EMBODIMENTS

Hereinafter, a model learning device, a model learning method, and a storage medium according to an embodiment of the present invention are described with reference to the drawings.

### [Entire Configuration]

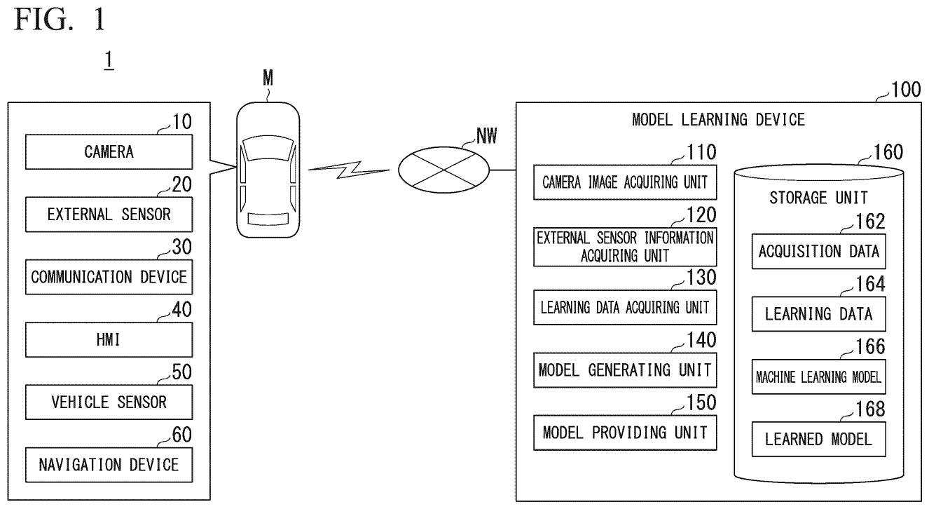

FIG. 1 is a configuration diagram of a model learning system 1 including a model learning device 100 according to an embodiment. The model learning system 1, for example, includes a vehicle (hereinafter, referred to as a subject vehicle M) and a model learning device 100. The subject vehicle M, for example, is a vehicle having two wheels, three wheels, four wheels, or the like or micromobility, and a driving source thereof is an internal combustion engine such as a diesel engine or a gasoline engine, an electric motor, or a combination thereof. The electric motor operates using power generated using a power generator connected to an internal combustion engine or discharge power of a battery (storage battery) such as a secondary cell or a fuel cell.

The subject vehicle M, for example, includes a camera 10, an external sensor 20, a communication device 30, a Human Machine Interface (HMI) 40, a vehicle sensor 50, and a navigation device 60. Such devices and equipment are connected to each other via multiplex communication lines such as CAN (Controller Area Network) communication lines, serial communication lines, a wireless communication network, and the like. The configuration illustrated in FIG. 1 is merely one example, a part of the configuration may be omitted, and furthermore other configurations may be added.

The camera 10, for example, is a digital camera using a solid-state imaging device such as a charge coupled device (CCD) or a complementary metal oxide semiconductor (CMOS). The camera 10 is installed at an arbitrary place in a vehicle (hereinafter, a subject vehicle M). In a case in which a side in front is to be imaged, the camera 10 is attached to an upper part of a front windshield, a rear face of a room mirror, or the like. The camera 10, for example, periodically images the vicinity of the subject vehicle M repeatedly. The camera 10 may be a stereo camera.

The external sensor 20 is a remote sensing sensor other than the camera 10 and is a Light Detection and Ranging (LIDAR) in this embodiment. The LIDAR emits light (or a radiowave having a wavelength close to light) to the vicinity of the subject vehicle M and measures scattered light. The LIDAR detects a distance to a target on the basis of a time from light emission to light reception. For example, the emitted light is pulse-shaped laser light. The LIDAR is attached to an arbitrary place in the subject vehicle M.

Alternatively, the external sensor 20 may be a radar device. The radar device emits radio waves such as millimeter waves to the vicinity of the subject vehicle M and detects at least a position of (a distance and an azimuth) a target object by detecting radio waves (reflected waves) reflected by the target object. The radar device is attached to an arbitrary place on the subject vehicle M. The radar device may detect a position and a speed of a target object using a frequency modulated continuous wave (FM-CW) system.

The communication device 30, for example, communicates with other vehicles present in the vicinity of the subject vehicle M, a terminal device of a user using the subject vehicle M, or various server apparatuses using a network such as a cellular network, a Wi-Fi network, Bluetooth (registered trademark), dedicated short range communication (DSRC), a local area network (LAN), or the Internet.

The Human Machine Interface (HMI) 40 outputs various kinds of information to an occupant (including a driver) of the subject vehicle M and receives an input operation performed by a vehicle occupant. The HMI 40, for example, a display unit and a speaker. The display unit, for example, is a liquid crystal display (LCD), an organic Electro Luminescence (EL) display device, or the like. The display unit displays various kinds of images (including videos) according to an embodiment. The display unit may be configured integrally with an input unit as a touch panel. The speaker outputs a predetermined voice (for example, a notification sound, a message voice, or the like). The HMI 40 may include a microphone, a buzzer, a touch panel, switches, keys, and the like. The switches may include a switch for executing or ending predetermined drive control or the like that can be executed by a vehicle control unit 170 to be described below, a switch for approving (permitting) or denying recommendation (proposal) of drive control on the system side, and the like. In addition, the switches may include a switch used for directional signaling (a turn-signal switch) and the like.

The vehicle sensor 50 includes a vehicle speed sensor that detects a speed of the subject vehicle M, an acceleration sensor that detects an acceleration, and a yaw rate sensor that detects a yaw rate (for example, a rotational angular velocity around the vertical axis passing through the center of gravity of the subject vehicle M). In addition, the vehicle sensor 50 may include a lateral acceleration sensor (lateral-G sensor) that detects the lateral acceleration (lateral G) of the subject vehicle M, a steering angle sensor that detects a steering angle (it may be an angle of a steering wheel or an operation angle of the steering wheel) of the subject vehicle M, a steering angular velocity sensor that detects the steering angular velocity, an orientation sensor that detects an orientation of the subject vehicle M, and the like.

Furthermore, the vehicle sensor 50 may also include a position sensor that detects a position of the subject vehicle M. The position sensor, for example, is a sensor that acquires position information (longitude and latitude information) from a Global Positioning System (GPS) device. The position sensor, for example, may be a sensor that acquires position information using a Global Navigation Satellite System (GNSS) receiver of the navigation device 60. The vehicle sensor 50 may derive the speed of the subject vehicle M from a difference (that is, a distance) between pieces of position information obtained by a position sensor over a predetermined time period. Results detected by the vehicle sensor 50 are output to the model learning device 100.

The navigation device 60, for example, includes a GNSS receiver, a navigation HMI, and a path determining unit. The navigation device 60 may store map information in a storage device such as a hard disk drive (HDD) or a flash memory. The GNSS receiver identifies the position of the subject vehicle M on the basis of signals received from GNSS satellites. The position of the subject vehicle M may be identified or complemented by an Inertial Navigation System (INS) using the output of the vehicle sensor 50. The navigation HMI includes a display device, a speaker, a touch panel, keys, and the like. The GNSS receiver may be installed in the vehicle sensor 50. A part or the whole of the navigation HMI may have be configured to be common to the HMI 40 described above.

### [Model Learning Device]

The model learning device 100, for example, includes a camera image acquiring unit 110, an external sensor information acquiring unit 120, a learning data acquiring unit 130, a model generating unit 140, a model providing unit 150, and a storage unit 160. Each of the camera image acquiring unit 110, the external sensor information acquiring unit 120, the learning data acquiring unit 130, the model generating unit 140, and the model providing unit 150, for example, is realized by a hardware processor such as a central processing unit (CPU) executing a program (software). Some or all of such constituent elements may be realized by hardware (a circuit unit; including circuitry) such as a Large Scale Integration (LSI), an Application Specific Integrated Circuit (ASIC), a Field-Programmable Gate Array (FPGA), a Graphics Processing Unit (GPU), or a System On Chip (SOC) or may be realized by software and hardware in cooperation. The program described above may be stored in advance in a storage device (a storage device including a non-transitory storage medium) such as an HDD, a flash memory, or the like of the model learning device 100 or may be stored in a loadable/unloadable storage medium such as a DVD, a CD-ROM, or a memory card and installed in the storage device of the model learning device 100 by mounting the storage medium (a non-transitory storage medium) in a drive device, a card slot, or the like. The storage unit 160, for example, stores acquisition data 162, learning data 164, a machine learning model 166, and a learned model 168. The storage unit 160, for example, is realized using a Read Only Memory (ROM), a flash memory, an SD card, a Random Access Memory (RAM), a register, and the like.

### [Acquisition of Camera Image]

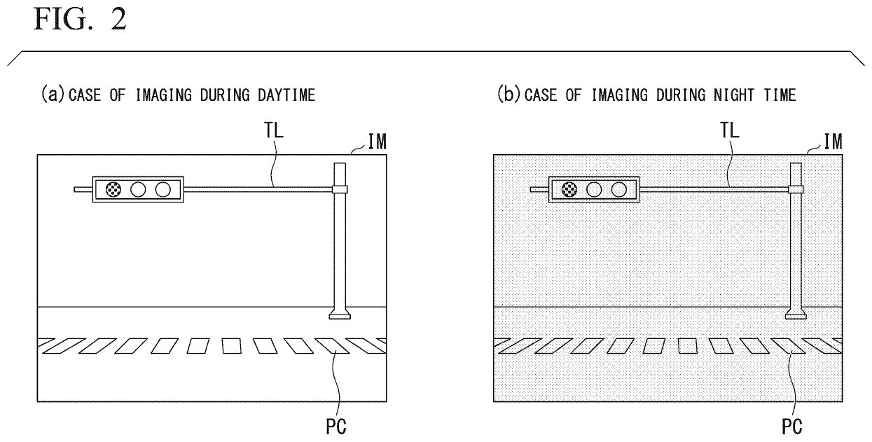

The camera image acquiring unit 110 acquires a plurality of images captured by the camera 10 from the camera 10. FIGS. 2A and 2B are diagrams illustrating examples of an image acquired by the camera image acquiring unit 110. FIG. 2A illustrates an image acquired by, in front of a pedestrian crossing PC and a traffic light, capturing a side in front of the subject vehicle M including such objects during the daytime, and FIG. 2B illustrates an image captured at the same position during the night time.

Although these images were captured at the same location, in a case in which when there are differences in the imaging environment even at the same location, differences in the feature quantities derived for the same feature point occur, and thus it becomes difficult to match pixels corresponding to the same feature point (a feature point of an object) between these images. Differences in the imaging environment may include, for example, differences in the time of imaging (average brightness) such as between day and night, differences in the date of imaging (season); differences in weather conditions (sunny, rainy, foggy, and the like), differences in the angle of incident sunlight entering the camera 10, and differences in the traveling conditions of the subject vehicle M at the time of imaging (an angle, a vehicle speed, and the like).

As a result, in a case in which information relating to a plurality of images and feature points acquired by imaging the same location is used as learning data and, for example, is used for learning of a machine learning model that detects feature points of a three-dimensional object, from conventional rule-based feature points, pixels representing the same feature point are not recognized, and there is a limit in the matching accuracy of feature points. In machine learning, although input images are numerically represented pixel by pixel and processed as vectors, if learning is performed without associating pixels that correspond to the same three-dimensional position, the learned model has difficulty in robustly detecting feature points according to differences in the imaging environments. Regarding this problem, it is considered to derive setting of robust feature points through machine learning. However, learning of a model requires a large amount of learning data, and fixed-point imaging as illustrated in FIGS. 2A and 2B requires significant time and effort, whereby the data collection efficiency becomes low.

### [Acquisition of External Sensor Information]

For this reason, in this embodiment, position information of detection points detected from objects present in the vicinity of the subject vehicle Mis acquired using the external sensor 20 mounted in the subject vehicle M with the camera 10 and at least a part of a detection range overlapping each other and is associated with pixels of a captured image to be used as learning data. The external sensor information acquiring unit 120 acquires position information (more specifically, three-dimensional coordinates) of detection points detected by the external sensor 20 from the external sensor 20.

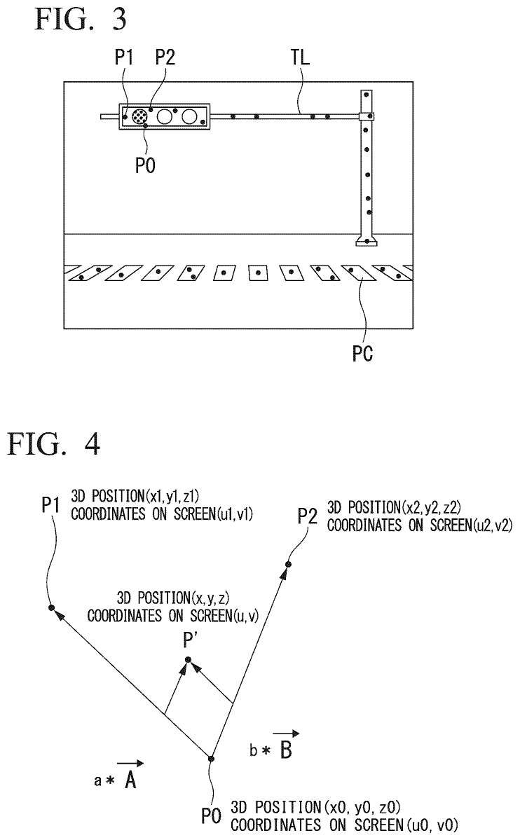

FIG. 3 is a diagram illustrating an example of position information acquired by the external sensor information acquiring unit 120. As described above, in this embodiment, the external sensor 20 is a LIDAR. For this reason, FIG. 3 illustrates an example in which point cloud data representing three-dimensional coordinates is acquired by the external sensor 20. In FIG. 3, for simplicity of explanation, only three points P0 to P2 in the point cloud data are represented with reference signs attached thereto.

A positional relation between the camera 10 and the external sensor 20 is calibrated in advance, and for this reason, in a case in which imaging using the camera 10 and the acquisition of point cloud data using the external sensor 20 are executed at the same timing, pixels of a captured image and the position information of the point cloud data can be associated with each other on the basis of the position information adjusted in advance. For this reason, the learning data acquiring unit 130 stores a captured image and the position information of point cloud data acquired at the same timing in the storage unit 160 while being associated with each other as acquisition data 162. Here, the association between a pixel of an image and LIDAR point cloud data is identifying a pixel that has imaged the same position as that of a predetermined LIDAR detection point from the image. In accordance with this, even in a case in which there are differences in the imaging environments, feature points of a plurality of images that have been acquired by imaging the same location can be associated with each other on the basis of the position information.

### [Interpolation of Position Information]

However, for example, as illustrated in FIG. 3, all the point cloud data acquired by the external sensor 20, which is a LIDAR, cannot be obtained exhaustively in correspondence with all the pixels of the image. The reason for this is that, generally, the resolution of the pixels of the camera 10 is higher than that of the external sensor 20 that is a LIDAR. As a result, there are pixels with which no position information is associated among the pixels of a captured image. For this reason, in this embodiment, the learning data acquiring unit 130, for a pixel (hereinafter, referred to as a target pixel) with which no position information is associated, acquires position information of the target pixel through interpolation on the basis of pixels with which position information is associated.

More specifically, the learning data acquiring unit 130 acquires position information of a target pixel from relative positions between the target pixel and a plurality of associated pixels and the position information of detection points corresponding to the plurality of associated pixels on the basis of a plurality of associated pixels of which corresponding detection points are present among pixels of an image. FIG. 4 is a diagram illustrating a method of acquiring position information of a target pixel using the learning data acquiring unit 130. In FIG. 4, points P0, P1, and P2 respectively represent the same points as the detection points P0, P1, and P2 of the point cloud data illustrated in FIG. 3, and point P1′ represents a target pixel that becomes a target of which the position information is to be acquired. In FIG. 4, the position information (x₀, y₀, z₀), (x₁, y₁, z₁), and (x₂, y₂, z₂) of the points P0, P1, and P2 and coordinates (u₀, v₀), (u₁, v₁), and (u₂, v₂) of pixels on the image are associated with each other. Here, the points P0, P1, and P2 are detection points of the LIDAR, and (x₀, y₀, z₀), (x₁, y₁, z₁), and (x₂, y₂, z₂) are known from detection results acquired by the LIDAR. In addition, the coordinates (u₀, v₀), (u₁, v₁), and (u₂, v₂) of the pixels on the image are derived on the basis of relative positions on the image and thus are known. In addition, in FIG. 4, reference sign A with an arrow thereabove represents a unit vector of a vector (a two-dimensional vector including an x component and a y component) directed from the point P0 to point P1, and reference sign B with an arrow thereabove represents a unit vector of a vector directed from point P0 to point P2. Since components (x₀, y₀), (x₁, y₁), and (x₂, y₂) of the points P0, P1, and P2 are all known, components (Aₓ, A_{y}) and (Bₓ, B_{y}) of the unit vectors A and B are likewise known.

The coordinates (u, v) of a target pixel P′ on the image are derived on the basis of a relative position on the image and thus are known, and the learning data acquiring unit 130 interpolates the unknown position information (x, y, z) of the target pixel P′ as below. First, the coordinates (u, v) of the target pixel P′ are expressed by the following Equation (1) using the coordinates (u0, v0) of the point P0, the unit vectors A and B, and unknown variables a and b.

$$( u , v ) = ( {u}_{0} , {v}_{0} ) + a {\to }_{A} + b {\to }_{B} \qquad ( 1 )$$

By expanding Equation (1) into its components, the following simultaneous equations (2) are obtained.

$$u = {u}_{0} + {aA}_{x} + {bB}_{x} \qquad ( 2 )$$

$$v = {v}_{0} + {aA}_{y} + {bB}_{y}$$

As described above, since u, v, u₀, v₀, Aₓ, A_{y}, Bₓ, and B_{y} are all known, the simultaneous equations (2) described above can be solved for a and b. Once the values of a and b are obtained in this way, the position information (x, y, z) of the target pixel P′ can be approximated by the following Equation (3).

$$( x , y , z ) = ( x 0 , y 0 , z 0 ) + \{ a / \vert ( x 1 - x 0 , y 1 - y 0 , z 1 - z 0 ) \vert \} ( x 1 - x 0 , y 1 - y 0 , z 1 - z 0 ) + \{ b / \vert ( x 2 - x 0 , y 2 - y 0 , z 2 - z 0 ) \vert \} ( x 2 - x 0 , y 2 - y 0 , z 2 - z 0 ) \qquad ( 3 )$$

The values of a and b are obtained on the basis of the positional relation (that is, a two-dimensional positional relation) of pixels between point P′ and the points P0, P1, and P2. For this reason, errors may occur in the interpolation of the three-dimensional coordinates of the point P′ using the values of a and b. For this reason, in selecting the points P0, P1, and P2, the learning data acquiring unit 130 may judge whether or not these points represent the same target object on the basis of detection results acquired by the external sensor 20, which is a LIDAR, in addition to a condition that they are points in the vicinity of the target pixel P′ on the screen.

More specifically, the learning data acquiring unit 130 judges whether or not differences in reflection intensity, which represents the strength of reflected pulses measured by the LIDAR, among three points are a predetermined value or less and, in a case in which the differences are judged to be the predetermined value or less, can judge that these three points represent the same target object. For example, the learning data acquiring unit 130 may judge whether or not the largest difference in reflection intensity among a difference between point P0 and point P1, a difference between point P0 and point P2, and a difference between point P1 and point P2 is a predetermined value or less. In addition, for example, the learning data acquiring unit 130 judges whether or not three-dimensional distances among three points are a predetermined value or less and, in a case in which the three-dimensional distance is judged to be the predetermined value or less, can judge that these three points represent the same target object. For example, the learning data acquiring unit 130 may judge whether or not the largest three-dimensional distance among a three-dimensional distance between point P0 and point P1, a three-dimensional distance between point P0 and point P2, and a three-dimensional distance between point P1 and point P2 is a predetermined value or less.

When the learning data acquiring unit 130 interpolates the position information for a target pixel, it associates the target pixel with the position information to generate learning data 164 and stores the learning data 164 in the storage unit 160. Through the processes described above, the learning data acquiring unit 130 can acquire the learning data 164 from the acquisition data 162.

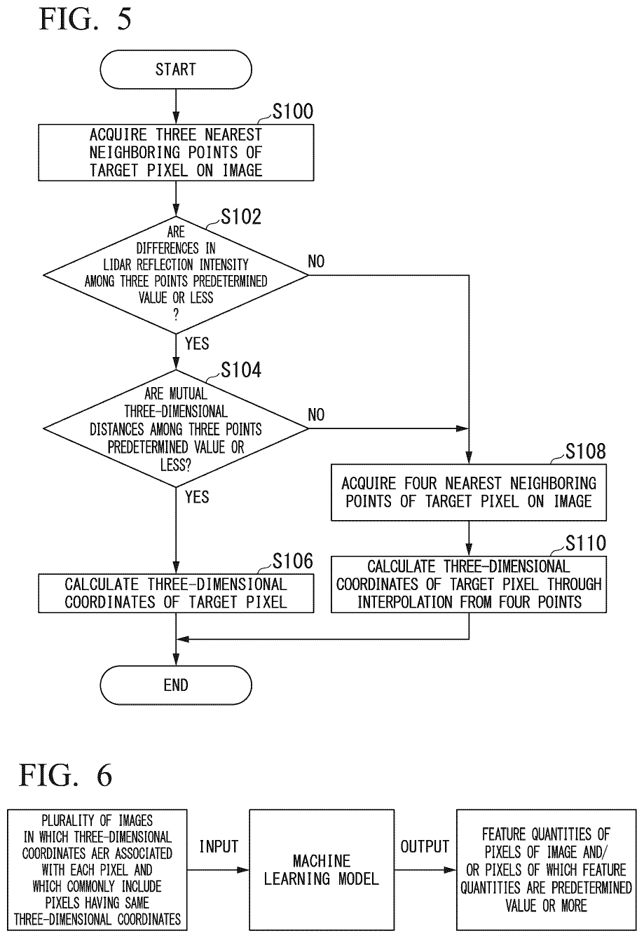

FIG. 5 is a flowchart illustrating an example of the flow in which the learning data acquiring unit 130 acquires learning data 164. The process of the flowchart illustrated in FIG. 5 is executed, for example, at a timing at which the camera 10 and the external sensor 20 include the same detection range, and a part of pixels of an image captured by the camera 10 is associated with position information obtained by the external sensor 20.

First, the learning data acquiring unit 130 acquires three nearest neighboring points on an image among pixels, which have been associated, with respect to a target pixel with which the position information acquired by the LIDAR is not associated in the image captured by the camera 10 (Step S100). Next, the learning data acquiring unit 130 judges whether or not differences in LiDAR reflection intensity among the three points are a predetermined value or less (Step S102). Next, in a case in which it is judged that the differences in LiDAR reflection intensity among the three points are the predetermined value or less, the learning data acquiring unit 130 judges whether or not mutual three-dimensional distances among the three points are a predetermined value or less (Step S104).

Next, when it is judged that the mutual three-dimensional distances among the three points are the predetermined value or less, the learning data acquiring unit 130 calculates three-dimensional coordinates of the target pixel on the basis of the three-dimensional coordinates of the three points and two-dimensional coordinates thereof on the image (Step S106). On the other hand, in Step S102, in a case in which the differences in LiDAR reflection intensity among the three points are larger than the predetermined value, or the mutual three-dimensional distances among the three points are judged to be larger than the predetermined value, the learning data acquiring unit 130 acquires four nearest neighboring points on the image with respect to the target pixel among associated pixels (Step S108). Next, the learning data acquiring unit 130 calculates three-dimensional coordinates of the target pixel through interpolation based on the position information of the four points (Step S110). In accordance with this, the process of this flowchart ends.

### [Learning of Machine Learning Model]

The model generating unit 140 performs learning of the machine learning model 166 on the basis of the learning data 164 acquired by the learning data acquiring unit 130 to generate a learned model 168. FIG. 6 is a diagram illustrating an example of the configuration of the machine learning model 166. As illustrated in FIG. 6, the machine learning model 166 is a machine learning model learned to take, as input, a plurality of images in which three-dimensional coordinates are associated with each pixel and which commonly include pixels having the same three-dimensional coordinates within the angle of view and to output feature quantities of the pixels of these images and/or pixels of which feature quantities are a predetermined value or more. The machine learning model 166 is, for example, a convolutional neural network (CNN: Convolutional Neural Network). When the model generating unit 140 generates the learned model 168, it stores the learned model 168 in the storage unit 160.

The feature quantities represent, for example, information such as the shape of an object shown in an image (for example, an edge, a contour, or a curvature), brightness (for example, a luminance value), a color (for example, an RGB color code), and the like. A feature quantity being a predetermined value or more includes, for example, a case in which the proportion of a linear component acquired through edge detection is a predetermined value or more, a case in which a luminance value (or a difference in the luminance value from an adjacent pixel) is a predetermined value or more, a case in which the R value of an RGB color code is a predetermined value or more, and the like. As described above, since feature points of a plurality of images acquired by imaging the same location are associated with each other using position information in the learning data 164 used for learning at this time, by performing learning using such learning data 164, robust feature quantity settings corresponding to environmental differences can be derived.

### [Provision of Learned Model]

When the model generating unit 140 generates a learned model 168, the model providing unit 150 provides the generated learned model 168 to the subject vehicle M (and/or other vehicles) via a network NW. While traveling, the subject vehicle M performs self-position estimation (localization) and environment map generation (mapping) through Visual Simultaneous Localization and Mapping (SLAM) by using the provided learned model 168. More specifically, the subject vehicle M captures images in a times series by using the camera 10, inputs the images captured in the time series to the learned model 168, and obtains feature quantities of pixels of the images and/or pixels of which feature quantities are a predetermined value or more in a time series. The subject vehicle M can use the pixel feature quantities of the pixels in a time series and/or pixels of which feature quantities are the predetermined value or more, which have been output from the learned model 168, as point cloud data of Visual SLAM.

In addition, instead of providing the learned model 168 for the subject vehicle M (and/or other vehicles), the model learning device 100 may execute Visual SLAM using the learned model 168 and provide self-position estimation results obtained through the Visual SLAM and the generated environment map for the subject vehicle M (and/or other vehicles).

### [Flow of Process]

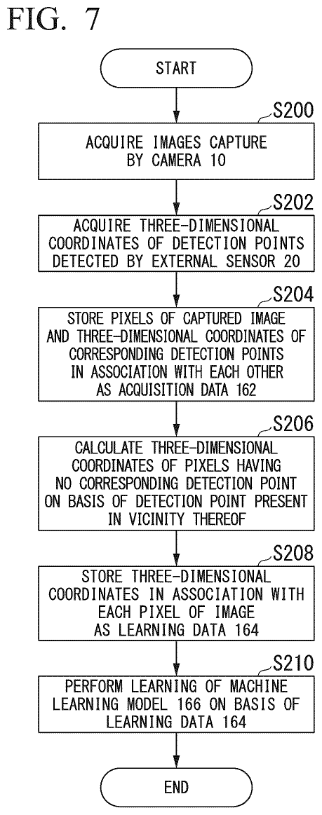

Hereinafter, the flow of a process according to this embodiment is described with reference to FIG. 7. FIG. 7 is a flowchart illustrating an example of the flow of model learning performed by the model learning device 100.

First, the camera image acquiring unit 110 acquires images captured by the camera 10 (Step S200). Next, the external sensor information acquiring unit 120 acquires three-dimensional coordinates of detection points detected by the external sensor 20 (Step S202). Next, the learning data acquiring unit 130 stores the pixels of the captured images and the three-dimensional coordinates of corresponding detection points in the storage unit 160 as acquisition data 162 in association with each other (Step S204).

Next, the learning data acquiring unit 130 calculates the three-dimensional coordinates of pixels that do not have corresponding detection points on the basis of detection points present in the vicinity thereof (Step S206). Next, the learning data acquiring unit 130 associates three-dimensional coordinates with each pixel of the image and stores them as learning data 164 (Step S208). Next, the model generating unit 140 performs learning of the machine learning model 166 on the basis of the learning data 164 and generates a learned model 168 (Step S210). In accordance with this, the process of this flowchart ends.

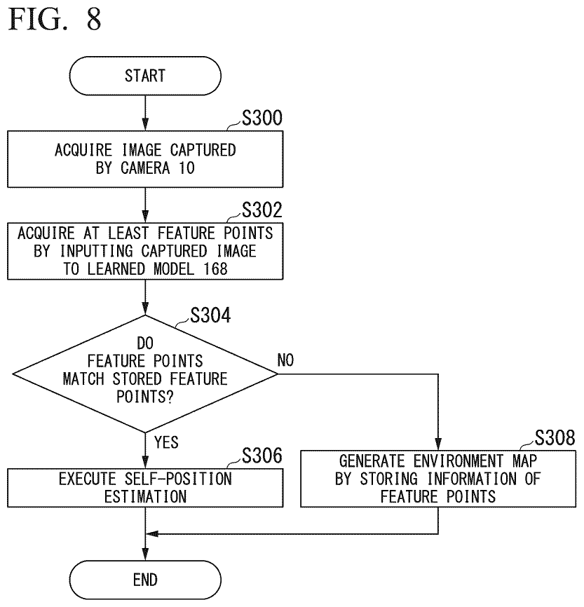

FIG. 8 is a flowchart illustrating an example of the flow of self-position estimation performed by the subject vehicle M in which the learned model 168 is mounted. The process of the flowchart illustrated in FIG. 8, for example, is repeatedly executed during the traveling of the subject vehicle M. The subject vehicle M may be caused to execute the process of the flowchart illustrated in FIG. 8 via a network NW with the model learning device 100 functioning as a control device of the subject vehicle M.

First, the subject vehicle M acquires an image (a surrounding image of the subject vehicle M) captured by the camera 10 (Step S300). Next, the subject vehicle M inputs the captured image to the learned model 168 to acquire at least feature points of this image (Step S302). Next, the subject vehicle M judges whether or not the acquired feature points match stored feature points (Step S304).

In a case in which it is judged that the acquired feature points match the stored feature points, the subject vehicle M can localize the subject vehicle M on the basis of these feature points (Step S306). On the other hand, in a case in which it is judged that the acquired feature points do not match the stored feature points (or in a case in which the process of the flowchart is being performed for the first time), the subject vehicle M stores the acquired feature points and generates an environment map (Step S308). In accordance with this, the process of this flowchart ends.

According to this embodiment described above, pixels of an image of the vicinity of a mobile body captured by a camera mounted in the mobile body and position information of detection points acquired from an external sensor mounted in the mobile body with the camera and at least a part of a detection range overlapping each other are acquired in association with each other, and position information of target pixels for which corresponding detection points are not present among the pixels is acquired on the basis of results of acquisition of the position information of the detection points. In other words, by enhancing the association with information of an external sensor other than a camera, the number of pixels of which position information has been acquired can be increased, and thus the amount of learning data can be increased. Furthermore, the efficiency of collection of learning data can be improved.

The embodiment described above can be expressed as below.

A model learning device that includes a storage medium storing computer-readable instructions and a processor connected to the storage medium described above and is configured such that the processor executes the computer-readable instructions to: acquire an image of the vicinity of a mobile body from a camera mounted in the mobile body; acquire position information of detection points detected from objects in the vicinity of the mobile body from an external sensor mounted in the mobile body with the camera and at least a part of a detection range overlapping each other; acquire position information of pixels by associating the pixels of the image and the detection points with each other on the basis of the image and results of acquisition of the position information of the detection points; and acquire position information of target pixels for which no corresponding detection point is present among the pixels on the basis of results of acquisition of the position information of the detection points.

As above, although the embodiments have been described in forms for performing the present invention, the present invention is not limited to such embodiments at all, and various modifications and substitutions can be performed in a range not departing from the concept of the present invention.

What is claimed is:

1. A model learning device comprising:
a storage medium storing computer-readable instructions; and
a processor connected to the storage medium,
the processor executing the computer-readable instructions to: acquire an image of the vicinity of a mobile body from a camera mounted in the mobile body; acquire position information of detection points detected from objects in the vicinity of the mobile body from an external sensor mounted in the mobile body with the camera and at least a part of a detection range overlapping each other; and acquire position information of pixels by associating the pixels of the image and the detection points with each other on the basis of the image and results of acquisition of the position information,
wherein the processor acquires position information of target pixels for which no corresponding detection point is present among the pixels on the basis of the results of acquisition of the position information.

2. The model learning device according to claim 1,
wherein the processor generates a learned model on the basis of the results of acquisition of the position information,
wherein the processor generates the learned model by causing a machine learning model to perform learning using a plurality of acquired images as input images, and
wherein all the plurality of input images include pixels imaging a predetermined location to be common within an angle of view.

3. The model learning device according to claim 2, wherein the machine learning model has feature quantities of pixels of an image and/or pixels of which feature quantities are a predetermined value or more as outputs.

4. The model learning device according to claim 1, wherein the processor acquires the position information of the target pixels from relative positions between the target pixels in the image and a plurality of associated pixels and position information of the detection points corresponding to the plurality of associated pixels on the basis of the plurality of associated pixels for which the corresponding detection points are present among the pixels of the image.

5. The model learning device according to claim 4, wherein a plurality of detection points corresponding to the plurality of associated pixels have differences in reflection intensity and/or distances that are a predetermined value or less.

6. A model learning method using a computer, the model learning method comprising:
acquiring an image of the vicinity of a mobile body from a camera mounted in the mobile body;
acquiring position information of detection points detected from objects in the vicinity of the mobile body from an external sensor mounted in the mobile body with the camera and at least a part of a detection range overlapping each other;
acquiring position information of pixels by associating the pixels of the image and the detection points with each other on the basis of the image and results of acquisition of the position information of the detection points; and
acquiring position information of target pixels for which no corresponding detection point is present among the pixels on the basis of results of acquisition of the position information of the detection points.

7. A computer-readable non-transitory storage medium storing a program causing a computer to:
acquire an image of the vicinity of a mobile body from a camera mounted in the mobile body;
acquire position information of detection points detected from objects in the vicinity of the mobile body from an external sensor mounted in the mobile body with the camera and at least a part of a detection range overlapping each other;
acquire position information of pixels by associating the pixels of the image and the detection points with each other on the basis of the image and results of acquisition of the position information of the detection points; and
acquire position information of target pixels for which no corresponding detection point is present among the pixels on the basis of results of acquisition of the position information of the detection points.
